(19) United States
(12) Patent Application Publication
(10) Pub. No.: US 2017/0090577 A1
(43) Pub. Date: Mar. 30, 2017

(54) HAPTIC EFFECTS DESIGN SYSTEM

(71) Applicant: Immersion Corporation, San Jose, CA (US)

(72) Inventor: William S. RIHN, San Jose, CA (US)

(21) Appl. No.: 15/274,412

(22) Filed: Sep. 23, 2016

Related U.S. Application Data
(60) Provisional application No. 62/233,120, filed on Sep. 25, 2015.

(51) Int. Cl. G06F 3/01; A63F 13/285; G06T 1/20; G06T 13/20; G06T 13/80

(52) U.S. Cl. CPC G06F 3/016; G06T 13/20; G06T 13/80; G06T 1/20; A63F 13/285

(57) ABSTRACT

The systems and methods described herein are used to edit haptic effects in real-time. At the outset, an animation object is received. A haptic effect is associated with the animation object, the haptic effect having a corresponding haptic drive signal. Subsequently, interpolation points are associated with the haptic drive signal along a timeline. One or more parameters of the haptic drive signal are adjusted between successive interpolation points to generate a modified haptic effect. While adjusting the parameters, the animation object and the modified haptic effects may be rendered.

### CROSS-REFERENCE TO RELATED APPLICATIONS

This application claims the benefits of U.S. Provisional Patent Application No. 62/233,120, filed on Sep. 25, 2015, which is hereby incorporated herein by reference in its entirety.

### FIELD OF INVENTION

The embodiments of the present invention are generally directed to electronic devices, and more particularly, to electronic devices that produce and edit haptic effects.

### BACKGROUND

Haptics relate to tactile and force feedback technology that takes advantage of a user's sense of touch by applying haptic feedback effects (i.e., “haptic effects”), such as forces, vibrations, and motions, to the user. Devices, such as mobile devices, touchscreen devices, and personal computers, can be configured to generate haptic effects. For example, when a user interacts with the device using, for example, a button, touchscreen, lever, joystick, wheel, or some other control element, the operating system of the device can send a command through control circuitry to produce the appropriate haptic effect.

Devices can be configured to coordinate the output of haptic effects with the output of other content, such as audio, so that the haptic effects are incorporated into the other content. For example, an audio effect developer can develop audio effects that can be output by the device, such as machine gun fire, explosions, or car crashes. Further, other types of content, such as video effects, can be developed and subsequently output by the device.

A haptic effect developer can author a haptic effect for the device, and the device can be configured to output the haptic effect along with the other content. However, such a process generally requires the individual judgment of the haptic effect developer to author a haptic effect that correctly compliments the audio effect, or other type of content. A poorly-authored haptic effect that does not compliment the audio effect, or other type of content, can produce an overall dissonant effect where the haptic effect does not “mesh” with the audio effect or other content. This type of user experience is generally not desired.

### SUMMARY OF THE INVENTION

Embodiments of the present invention are directed toward electronic devices configured to produce and edit haptic effects that substantially improve upon the prior art.

Features and advantages of the embodiments are set forth in the description which follows, or will be apparent from the description, or may be learned by practice of the invention.

In one example, systems and methods for editing haptic effects are provided. For example, the systems and methods may be configured to retrieve an animation object, associate a haptic effect with the animation object, the haptic effect having a corresponding haptic drive signal, associate a plurality of interpolation points with the haptic drive signal along a timeline of the haptic drive signal, adjust one or more parameters of the haptic drive signal between successive interpolation points to generate a modified haptic effect, and render the animation object and the modified haptic effects. Thus, the embodiments of the present invention improve upon the generation and editing of haptic effects.

### BRIEF DESCRIPTION OF THE DRAWINGS

Further embodiments, details, advantages, and modifications will become apparent from the following detailed description of the preferred embodiments, which is to be taken in conjunction with the accompanying drawings.

FIG. 1 is a block diagram of a haptically-enabled system/device according to an example embodiment of the present invention.

FIG. 2 illustrates a haptic editing application according to an example embodiment of the present invention.

FIG. 3 illustrates a flow diagram of a functionality for editing haptic effects according to an example embodiment of the present invention.

FIG. 4 illustrates a haptic drive signal according to an example embodiment of the present invention.

FIGS. 5A-5C illustrates haptic drive signals according to other example embodiments of the present invention.

FIGS. 6A-6B illustrates haptic drive signals according to yet other example embodiments of the present invention.

FIGS. 7A-7B illustrate haptic drive signals according to yet other example embodiments of the present invention.

FIG. 8 illustrates multiple haptic drive signals according to another example embodiment of the present invention.

FIG. 9 illustrates a haptic preset library according to an example embodiment of the present invention.

### DETAILED DESCRIPTION

Reference will now be made in detail to embodiments, examples of which are illustrated in the accompanying drawings. In the following detailed description, numerous specific details are set forth in order to provide a thorough understanding of the present invention. However, it will be apparent to one of ordinary skill in the art that the present invention may be practiced without these specific details. In other instances, well-known methods, procedures, components, and circuits have not been described in detail so as not to unnecessarily obscure aspects of the embodiments. Wherever possible, like reference numbers will be used for like elements.

The example embodiments are generally directed to systems and methods for designing and/or editing haptic effects in a game engine or other non-linear engine whereby animation objects and accompanying media effects (e.g., audio and/or video) are rendered in sync with the haptic effects to enable real-time preview and monitoring of the haptic effects in an application context (e.g., a gaming context). An improved haptic editing application is provided to enhance the range of haptic effects rendered by high quality haptic output devices, and to further enhance a haptic developer's ability to design or otherwise manipulate the haptic effects. According to the various embodiments, the haptic effects may be rendered in real-time or during a playback of an animation object or other input.

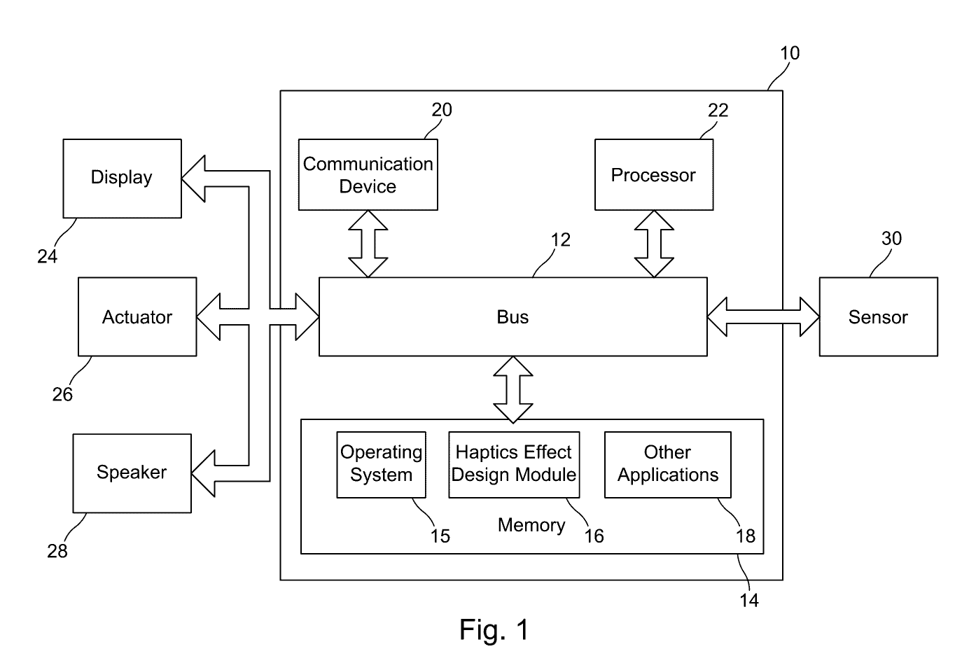

FIG. 1 is a block diagram of a haptically-enabled system/device 10 according to an example embodiment of the present invention.

In the various example embodiments, system 10 is part of a mobile device (e.g., a smartphone) or a non-mobile device (e.g., desktop computer), and system 10 provides haptics functionality for the device. In another example embodiment, system 10 is part of a device that is incorporated into an object in contact with a user in any way, and system 10 provides haptics functionality for such device. For example, in one embodiment, system 10 may include a wearable device, and system 10 provides haptics functionality for the wearable device. Examples of wearable devices include wrist bands, headbands, eyeglasses, rings, leg bands, arrays integrated into clothing, or any other type of device that a user may wear on a body or can be held by a user. Some wearable devices can be “haptically enabled,” meaning they include mechanisms to generate haptic effects. In another example embodiment, system 10 is separate from the device (e.g., a mobile device or a wearable device), and remotely provides haptics functionality for the device.

Although shown as a single system, the functionality of system 10 can be implemented as a distributed system. System 10 includes a bus 12 or other communication mechanism for communicating information, and a processor 22 coupled to bus 12 for processing information. Processor 22 may be any type of general purpose processor, or could be a processor specifically designed to provide haptic effects, such as an application-specific integrated circuit (“ASIC”). Processor 22 may be the same processor that operates the entire system 10, or may be a separate processor. Processor 22 can determine what haptic effects are to be rendered and the order in which the effects are rendered based on high level parameters. In general, the high level parameters that define a particular haptic effect include magnitude, frequency and duration. Low level parameters such as streaming motor commands could also be used to determine a particular haptic effect. A haptic effect may be considered “dynamic” if it includes some variation of these parameters when the haptic effect is generated or a variation of these parameters based on a user's interaction.

Processor 22 outputs the control signals to a haptic drive circuit (not shown), which includes electronic components and circuitry used to supply actuator 26 with the required electrical current and voltage (i.e., “motor signals”) to cause the desired haptic effects. In the example embodiment depicted in FIG. 1, actuator 26 is coupled to system 10. Alternatively, system 10 may include more than one actuator 26, and each actuator may include a separate drive circuit, all coupled to a common processor 22.

Processor 22 and the haptic drive circuit are configured to control the haptic drive signal of actuator 26 according to the various embodiments. A variety of parameters for the haptic drive signal may be modified. For example, the parameters may include start time, duration, loop count (i.e., the number of times the haptic effect is repeated), clip length (i.e., duration of a single instance of haptic effect that is repeated), signal type (i.e., direction of the haptic effect if rendered on a bidirectional actuator, such as push or pull), strength type (i.e., strength curve relative to the signal type for bidirectional actuators), signal gap (i.e., for a pulsing effect, the period of haptic silence between pulses), signal width (i.e., for a pulsing effect, the duration of each pulse), gap first (i.e., for a pulsing effect, specifies whether the haptic effect should begin with a pulse or a gap), link gap to width (i.e., ratio between width and gap parameters), signal shape (e.g., sine, square, triangle, saw tooth, etc.), and other parameters. Using these parameters, the haptic effects of an application may be edited and rendered in real-time.

Non-transitory memory 14 may include a variety of computer-readable media that may be accessed by processor 22. In the various embodiments, memory 14 and other memory devices described herein may include a volatile and nonvolatile medium, removable and non-removable medium. For example, memory 14 may include any combination of random access memory (“RAM”), dynamic RAM (“DRAM”), static RAM (“SRAM”), read only memory (“ROM”), flash memory, cache memory, and/or any other type of non-transitory computer-readable medium. Memory 14 stores instructions executed by processor 22. Among the instructions, memory 14 includes instructions for haptic effect design module 16. Haptic effect design module 16 includes instructions that, when executed by processor 22, enables a haptic editing application and further renders the haptic effects using actuators 26, as disclosed in more detail below. Memory 14 may also be located internal to processor 22, or any combination of internal and external memory.

Actuator 26 may be any type of actuator or haptic output device that can generate a haptic effect. In general, an actuator is an example of a haptic output device, where a haptic output device is a device configured to output haptic effects, such as vibrotactile haptic effects, electrostatic friction haptic effects, temperature variation, and/or deformation haptic effects, in response to a drive signal. Although the term actuator may be used throughout the detailed description, the embodiments of the invention may be readily applied to a variety of haptic output devices. Actuator 26 may be, for example, an electric motor, an electro-magnetic actuator, a voice coil, a shape memory alloy, an electro-active polymer, a solenoid, an eccentric rotating mass motor (“ERM”), a harmonic ERM motor (“HERM”), a linear resonance actuator (“LRA”), a solenoid resonance actuator (“SRA”), a piezoelectric actuator, a macro fiber composite (“MFC”) actuator, a high bandwidth actuator, an electroactive polymer (“EAP”) actuator, an electrostatic friction display, an ultrasonic vibration generator, or the like. In some instances, the actuator itself may include a haptic drive circuit.

Additionally, or alternatively, system 10 may include or be coupled to other types of haptic output devices (not shown) that may be non-mechanical or non-vibratory devices such as devices that use electrostatic friction (“ESF”), ultrasonic surface friction (“USF”), devices that induce acoustic radiation pressure with an ultrasonic haptic transducer, devices that use a haptic substrate and a flexible or deformable surface or shape changing devices and that may be attached to a user's body, devices that provide projected haptic output such as a puff of air using an air jet, etc.

In general, an actuator may be characterized as a standard definition (“SD”) actuator that generates vibratory haptic effects at a single frequency. Examples of an SD actuator include ERM and LRA. By contrast to an SD actuator, an HD actuator or high fidelity actuator such as a piezoelectric actuator or an EAP actuator is capable of generating high bandwidth/definition haptic effects at multiple frequencies. HD actuators are characterized by their ability to produce wide bandwidth tactile effects with variable amplitude and with a fast response to transient drive signals. Although embodiments of the invention were prompted by higher quality actuators, such as bidirectional actuators that provide push/pull effects (e.g., on an ActiveFORCE game controller trigger element) or frequency modifiable actuators, the embodiments are not so limited and may be readily applied to any haptic output device.

System 10, in embodiments that transmit and/or receive data from remote sources, further includes a communication device 20, such as a network interface card, to provide mobile wireless network communication, such as infrared, radio, Wi-Fi, cellular network communication, etc. In other embodiments, communication device 20 provides a wired network connection, such as an Ethernet connection, a modem, etc.

Processor 22 is further coupled via bus 12 to a display 24, such as a Liquid Crystal Display (“LCD”), for displaying a graphical representation or user interface to a user. The display 24 may be a touch-sensitive input device, such as a touch screen, configured to send and receive signals from processor 22, and may be a multi-touch touch screen.

In the various embodiments, system 10 includes or is coupled to a speaker 28. Processor 22 may transmit an audio signal to speaker 28, which in turn outputs audio effects. Speaker 28 may be, for example, a dynamic loudspeaker, an electrodynamic loudspeaker, a piezoelectric loudspeaker, a magnetostrictive loudspeaker, an electrostatic loudspeaker, a ribbon and planar magnetic loudspeaker, a bending wave loudspeaker, a flat panel loudspeaker, a heil air motion transducer, a plasma arc speaker, a digital loudspeaker, etc. In alternate embodiments, system 10 may include one or more additional speakers, in addition to speaker 28 (not illustrated in FIG. 1). System 10 may not include speaker 28, and a separate device from system 10 may include a speaker that outputs the audio effects, and system 10 sends audio signals to that device through communication device 20.

System 10 may further include or be coupled to a sensor 30. Sensor 30 may be configured to detect a form of energy, or other physical property, such as, but not limited to, sound, movement, acceleration, biological signals, distance, flow, force/pressure/strain/bend, humidity, linear position, orientation/inclination, radio frequency, rotary position, rotary velocity, manipulation of a switch, temperature, vibration, visible light intensity, etc. Sensor 30 may further be configured to convert the detected energy, or other physical property, into an electrical signal, or any signal that represents virtual sensor information. Sensor 30 may be any device, such as, but not limited to, an accelerometer, a galvanic skin response sensor, a capacitive sensor, a hall effect sensor, an infrared sensor, an ultrasonic sensor, a pressure sensor, a fiber optic sensor, a flexion sensor (or bend sensor), a force-sensitive resistor, a load cell, a LuSense CPS2 155, a miniature pressure transducer, a piezo sensor, a strain gauge, a hygrometer, a linear position touch sensor, a linear potentiometer (or slider), a linear variable differential transformer, a compass, an inclinometer, a magnetic tag (or a radio frequency identification tag), a rotary encoder, a rotary potentiometer, a gyroscope, an on-off switch, a temperature sensor (such as a thermometer, thermocouple, resistance temperature detector, thermistor, temperature-transducing integrated circuit, etc.), a microphone, a photometer, an altimeter, a biological monitor, a camera, a light-dependent resistor, etc., or any device that outputs an electrocardiogram, an electroencephalogram, an electromyograph, an electrooculogram, an electro-palatograph, or any other electrophysiological output.

In alternate embodiments, system 10 may include or be coupled to one or more additional sensors (not illustrated in FIG. 1), in addition to sensor 30. In some of these embodiments, sensor 30 and the one or more additional sensors may be part of a sensor array, or some other type of collection/arrangement of sensors. Further, in other alternate embodiments, system 10 may not include sensor 30, and a separate device from system 10 includes a sensor that detects a form of energy, or other physical property, and converts the detected energy, or other physical property, into an electrical signal, or other type of signal that represents virtual sensor information. The device may then send the converted signal to system 10 through communication device 20.

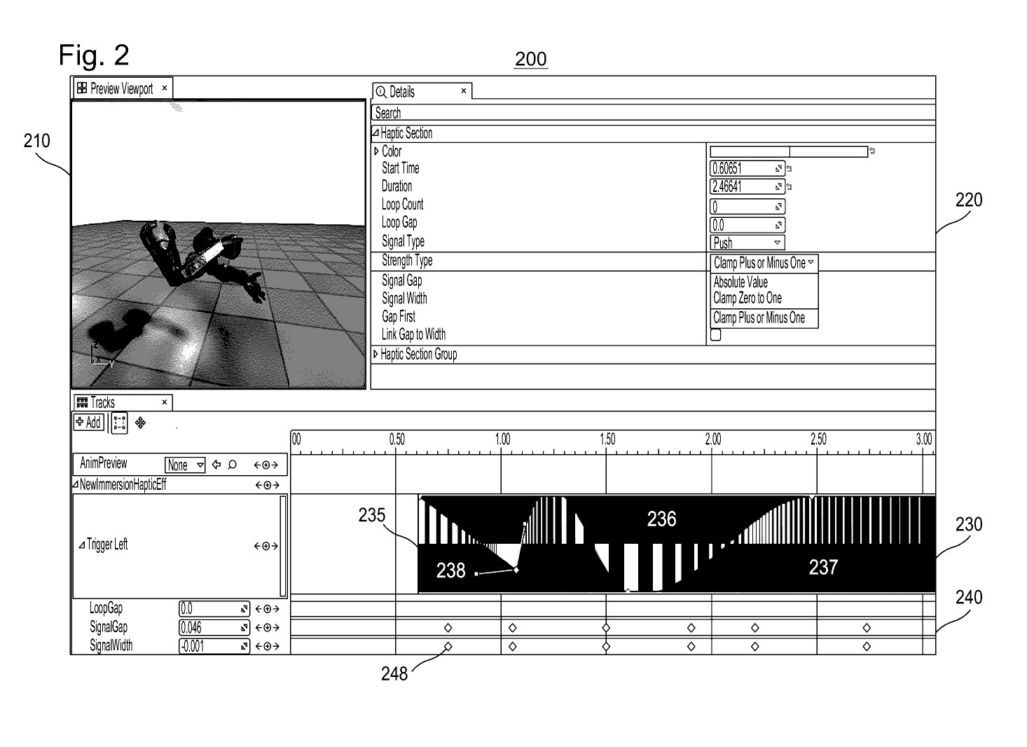

FIG. 2 illustrates a haptic editing application 200 according to an example embodiment of the present invention. In performing the functionality of editing one or more haptic effects for an application (e.g., a gaming application), media editing application 200 renders one or more user-interfaces, such as the example interfaces depicted in FIG. 2, including a visual preview 210, parameter modules 220, timeline editor 230, and interpolator modules 240. Although not shown, an additional user-interface may be displayed to render the application itself so that the application may be used while editing the haptic effects.

As shown in FIG. 2, haptic editing application 200 is configured to perform the functionality of editing one or more haptic effects for a visual preview 210, such as a two-dimensional or three-dimensional animation object. Visual preview 210 may include one or more imported two-dimensional or three-dimensional animation objects (e.g., an object representing a user's body, a body part, a physical object, or a combination thereof). Animation objects may graphically depict any physical object or game character, for example. Additional animations, such as particle effects, may also be used. Animation of such three-dimensional objects may be pre-determined, or alternatively, may be rendered in real-time based on movements or inputs of the user.

When multiple animations are used, one or more blended animations, composite animations, or montage animations may be generated. For example, the three-dimensional animations may be blended or otherwise modified using any visual programming language (“VPL”). Alternatively, or additionally, the user may select to modify one or more portions of visual preview 210, or the entire visual preview. In the event that multiple animations are combined sequentially, their combination may be applied to a single timeline, such as in timeline editor 230. Here, one or more haptic files (e.g., HAPT or haptic files) may be used.

In the illustrated embodiment, visual preview 210 is a three-dimensional animation that may be rendered based on the user's interaction with the application. Accordingly, visual preview 210 may further include acceleration signals, orientation signals, and other data captured with a sensor, gyroscope, accelerometer, or other motion sensing device.

In some instances, visual preview 210 may further include or be associated with a media signal and/or other signals. For example, the audio signal may be used to render sound effects synchronously with the haptic effects. In another example, one or more additional signals may be used to render other effects, such as particle effects.

Haptic editing application 200 further includes parameter modules 220. Within parameter modules 220, a variety of parameters for a haptic drive signal 235 (i.e., a visualization of a haptic drive signal applied to the actuator of FIG. 1) may be modified. For example, the parameters may include the start time, duration, loop count, clip length, signal type, strength type, signal gap, signal width, gap first, link gap to width, signal shape, etc. Using these parameters, the haptic effects of the application may be edited and rendered in real-time.

By altering parameter modules 220, one or more multi-frequency haptic effects may be rendered or simulated even if using a mono-frequency haptic output device. For example, by altering the signal width and signal gap parameters, one or more multi-frequency haptic effects may be simulated without altering the envelope of haptic drive signal 235. In another example, different textures may be rendered by narrowing the signal width and signal gap parameters of a repeated or looped haptic clip or drive signal.

In addition, the haptic effects may be visually depicted and modified using timeline editor 230. Within timeline editor 230, the parameters and the envelope of haptic drive signal 235 are visually rendered. At any given point along haptic drive signal 235, the magnitude of the envelope indicates the strength of the corresponding haptic effect. Although one haptic drive signal 235 is shown, additional haptic drive signals may be added, removed, or modified. Each haptic drive signal may correspond to one or more haptic channels or haptic output devices (e.g., a left game controller trigger). Alternatively, multiple haptic drive signals may be simultaneously or sequentially applied to a single haptic output device.

In order to modify haptic drive signal 235, one or more control points 238 or interpolation points 248 may be used. Each control point 238 and interpolation point 248 may be used to define subsequent parameters of haptic drive signal 235. However, control points 238 may further be used to define or modify the envelope of haptic drive signal 235. Between successive control points 238, portions of the envelope of haptic drive signal 235 may be linear or curved. For example, predefined or custom curves may be used such as logarithmic, exponential, and parabolic curves. In some instances, an additional curve may be used to determine the rate of interpolation. Alternatively, the envelope of haptic drive signal 235 may be fitted to a sine wave, square wave, triangle wave, saw tooth wave, etc. In the event that the envelope of the haptic drive signal is altered (e.g., using a curve), the magnitude of the haptic drive signal may change or change direction (e.g., a pull signal may become a push signal or vice versa).

In some instances, successive interpolation points 248 may be used to define one or more time periods (e.g., 1 second) for modifying one or more parameter values. Alternatively, control points 238 and interpolation points 248 may correspond to events of the application (e.g., crash, explosion, etc.). In another alternative configuration, parameter values between successive control points 238 or successive interpolation points 248 may be determined based on events of the application (e.g., acceleration or speed of a car or the strength of an explosion).

Example drive signal 235 is a push/pull haptic effect. A bidirectional haptic output device may be used to generate the push/pull haptic effect. Within section 236, haptic drive signal 235 has positive values and is a push signal. Conversely, haptic drive signal 235 has negative values within section 237 and is a pull signal. Although an example push/pull haptic drive signal is depicted, countless haptic drive signals 235 are feasible, and the embodiments of the invention are not so limited.

In some instances, visual preview 210 may include one or more tags (not shown) that identify points or frames for rendering haptic effects. An application programming interface (“API”) may be used to generate and/or modify the tags and their locations. Tags may also be referred to as “effect calls” or “notifies.” The tags may be generated by haptic drive signal 235 or generated manually prior to haptic drive signal 235. For example, the tags may be dynamically generated based on characteristics of haptic drive signal 235. By using the tags, the animation and the corresponding haptic effects may be rendered at a variable speed (e.g., slow motion or speeded motion). In addition, the tags may be used to synchronize the animation to haptic drive signal 235.

Although not shown, a group of haptic drive signals 235 may be selected for editing. Upon selection of the group of haptic drive signals, changes to one or more parameters or other characteristics (e.g., envelope) of each haptic drive signal may be simultaneously modified and rendered. Other characteristics may include dynamic changing of frequency or strength, randomization, etc.

Thus, using haptic editing application 200, the animation objects and accompanying media may be rendered in sync with haptic effects to enable real-time preview and editing of the haptic effects within the application. Compared to known haptic editing applications, the embodiments of the present invention provide the ability to more easily manipulate the haptic effects. For example, previously known haptic editing applications were limited to linear (i.e., not parametric or curved) modifications. Moreover, additional parameters such as signal gap, signal width, link gap to width, and others may be more easily controlled. As a result, the multi-frequency effects may be more easily designed and rendered. In addition, by using a parametric approach, new haptic output devices may be more readily applied. The haptic drive signals may be more easily reconfigured to take advantage of the parameter ranges of the new haptic output devices, as they emerge. Also, the embodiments of the present invention are not analogous to audio editing applications which are limited to use of audio files that are pre-generated.

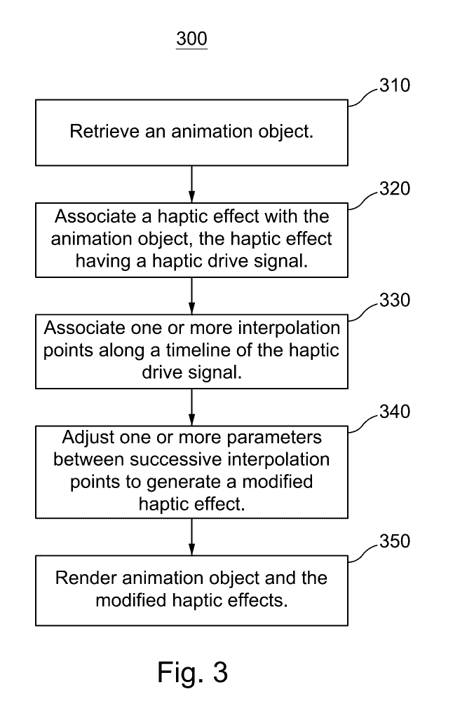

FIG. 3 illustrates a flow diagram of a functionality 300 for editing haptic effects according to an example embodiment of the present invention. In some instances, the functionality of the flow diagram of FIG. 3 is implemented by software stored in memory or other computer readable or tangible media, and executed by a processor. In other instances, the functionality may be performed by hardware (e.g., through the use of an application specific integrated circuit (“ASIC”), a programmable gate array (“PGA”), a field programmable gate array (“FPGA”), etc.), or any combination of hardware and software.

At 310, functionality 300 receives an animation object as an input. The animation object may include one or more two-dimensional or three-dimensional animation objects that are either pre-determined or rendered in real-time based on movements of the user. Animation objects may graphically depict any physical object or game character, for example. In some instances, the animation object may further include a media signal.

Next, at 320, functionality 300 associates one or more haptic effects with the animation object. Each of the haptic effects may have a corresponding haptic drive signal. Subsequently, functionality 300 associates a plurality of interpolation points with the haptic drive signal along a timeline of the haptic drive signal, at 330. Here, one or more parameters of the haptic drive signal may be adjusted between successive interpolation points to generate a modified haptic effect, at 340.

For example, portions of the envelope of the haptic drive signal may be linear or curved between successive interpolation points. Predefined or custom curves may be applied to modify the envelope of the haptic drive signal. In some instances, the interpolation points may be based on attributes and/or events of the application, such as speed (e.g., weaker haptic effects when slow, stronger haptic effects when fast). The interpolation points may also correspond to events of the application (e.g., crash, explosion, etc.). In another example, other parameters such as the signal width and/or signal gap may be altered to simulate multi-frequency haptic effects or different textures.

Lastly, the animation object and the corresponding modified haptic effects may be rendered, at 350. While adjusting the parameters, the animation object and the modified haptic effects may be rendered. The animation object may be rendered in the application, and the haptic effects may be rendered by the haptic output device, such as the actuator of FIG. 1.

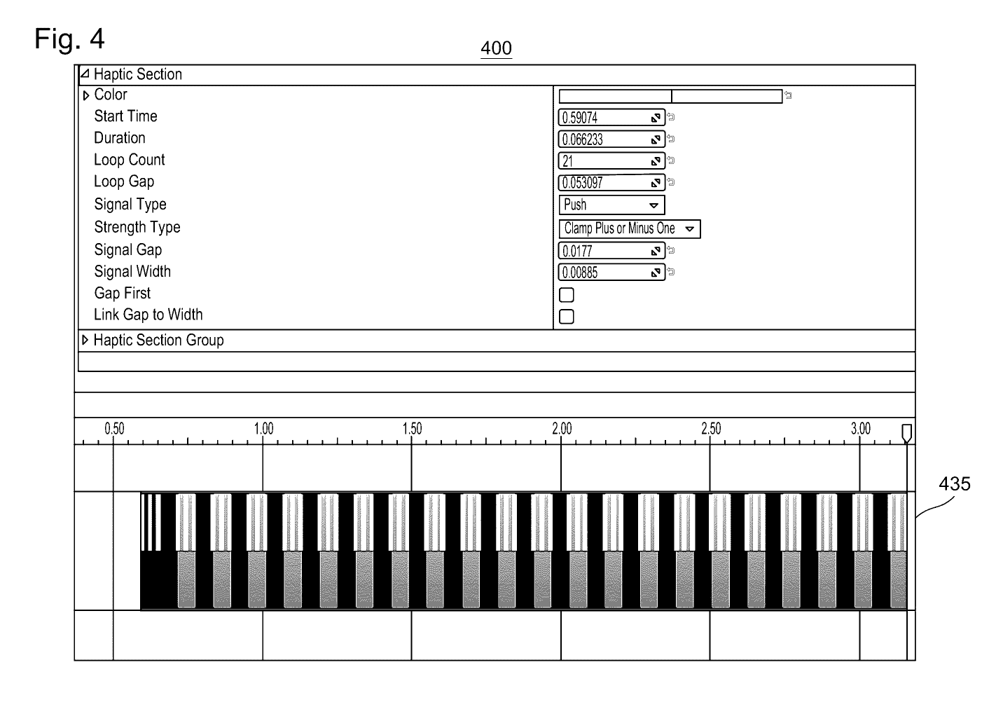

FIG. 4 illustrates a haptic drive signal 435 according to an example embodiment of the present invention. As shown in FIG. 4, haptic drive signal 435 may be used to render texture haptic effects, as described in U.S. patent application Ser. No. 12/697,042, entitled “Systems and Methods for Using Multiple Actuators to Realize Textures”, which is hereby incorporated by reference in its entirety. In particular, a variety of textures may be simulated by narrowing the signal width and signal gap parameters. In addition, the textured haptic effects may loop one or more clip signals in combination with a longer gap between loops. In some embodiments, the length of each clip in the loop may be modified over time using key frames.

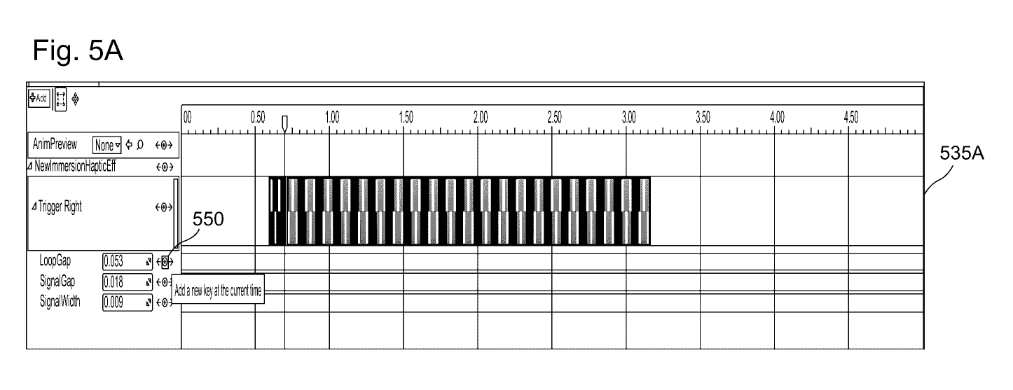

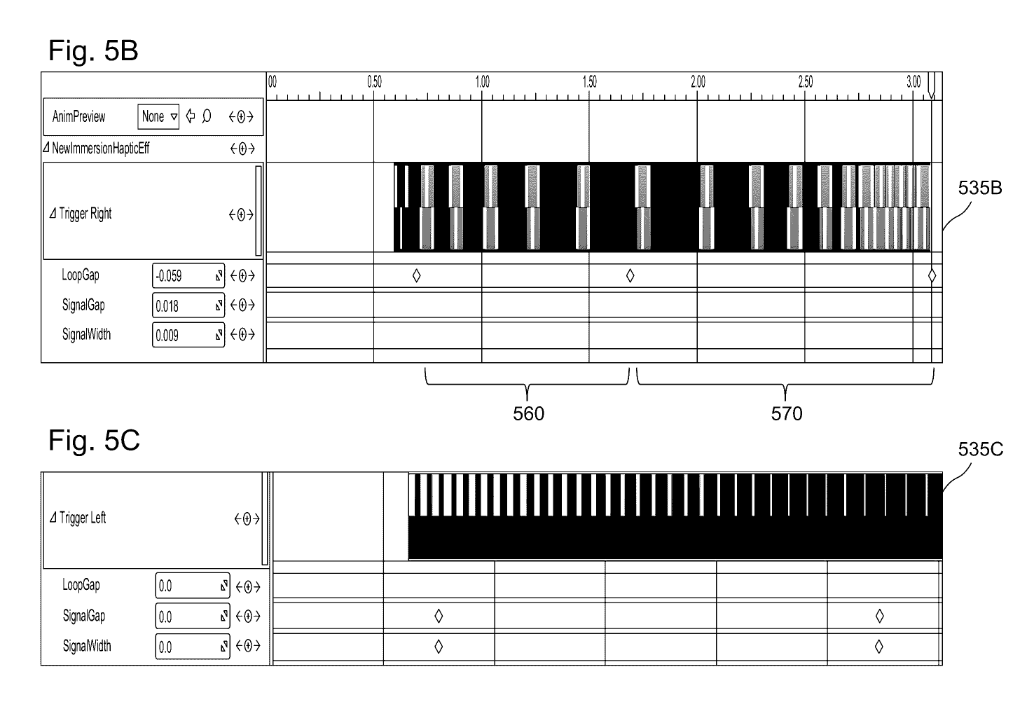

FIGS. 5A-5C illustrate haptic drive signals 535A, 535B, 535C according to another example embodiment of the present invention. In addition to modifying the various haptic parameters, haptic designers may modify parameters over time. In FIG. 5A, the parameters of base haptic drive signal 535A do not change over time. However, the haptic editing application may enable one or more parameters to follow an interpolation between key frames. For example, the loop gap, signal width, signal gap, clip length, and other parameters may be modified over time using key frames. The key frames may be used to override the base values of the haptic effect. For example, if the base frequency is 100 Hz, the key frame may be placed at the start, defaulting to 100 Hz. An additional key frame may be placed at the end of the haptic effect to override the frequency, set by the user to be 200 Hz. Between the key frames, one or more interpolation techniques may be applied (e.g., the frequency in the middle of the haptic effect may be 150 Hz if the user chooses a linear interpolation). Here, the key frames may be added using a key frame button 550.

Each of FIG. 5B and FIG. 5C illustrates that the haptic parameters change over time. In FIG. 5B, the loop gap parameter of haptic drive signal 535B may be increased in region 560, or decreased in region 570. In FIG. 5C, the signal gap parameter of haptic drive signal 535C increases over time. In addition, the signal width parameter of haptic drive signal 535C decreases over time.

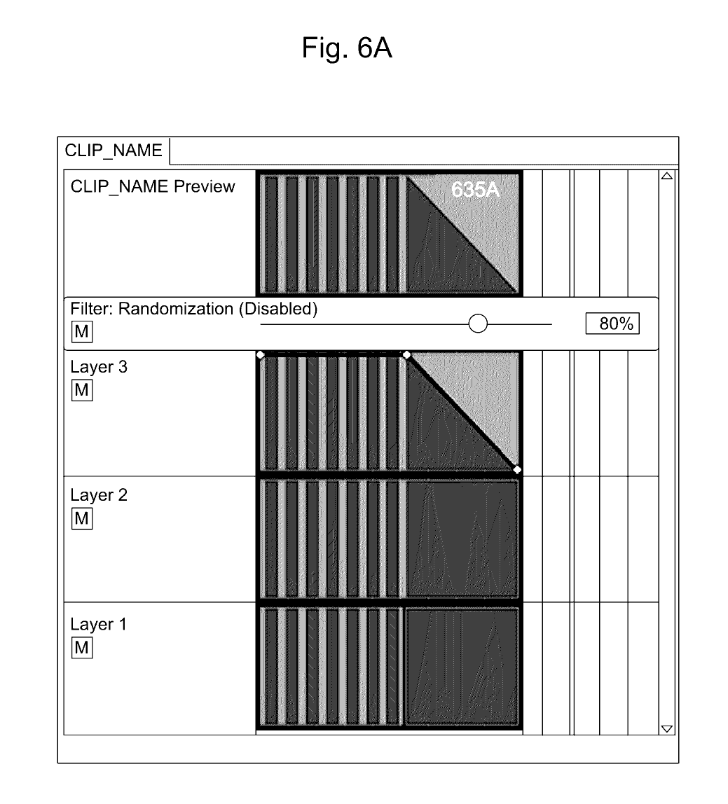

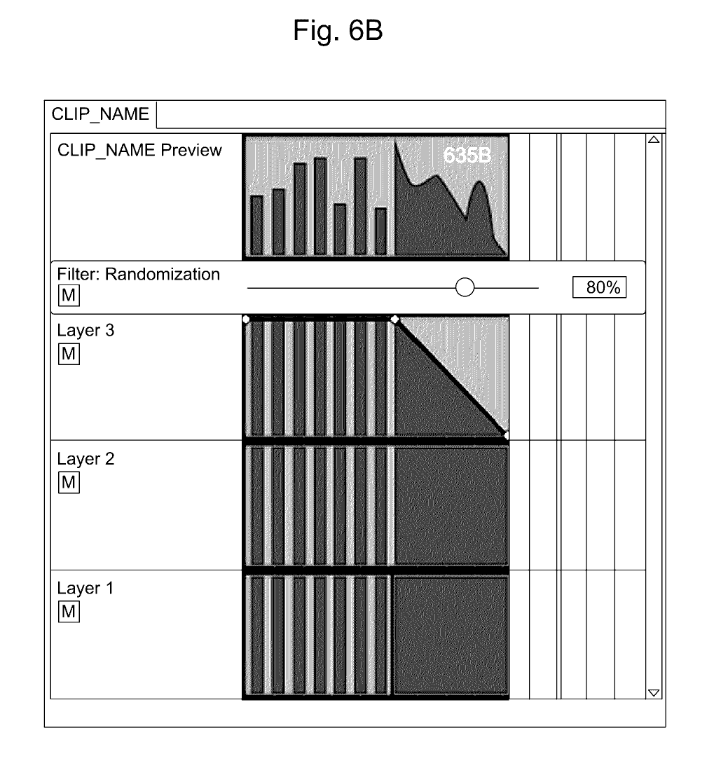

FIGS. 6A-6B illustrate haptic drive signals 635A, 635B according to other example embodiments of the present invention. FIG. 6A illustrates base haptic drive signal 635A. Haptic drive signal 635A has not been randomized or otherwise filtered. However, as shown in FIG. 6B, one or more portions of haptic drive signal 635B have been randomized. Randomization of haptic drive signal 635B may be achieved using one or more randomization algorithms or filters. Randomization may be used to simulate bumpy roads, exaggerate textures, make things feel “electrified,” etc. Generally, randomization adds an additional perception of dynamics and immersion.

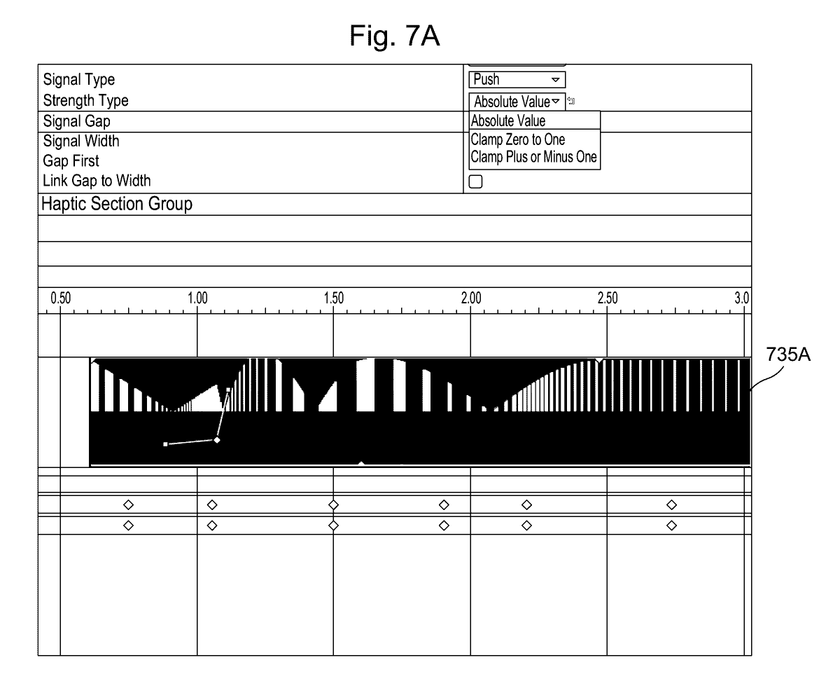

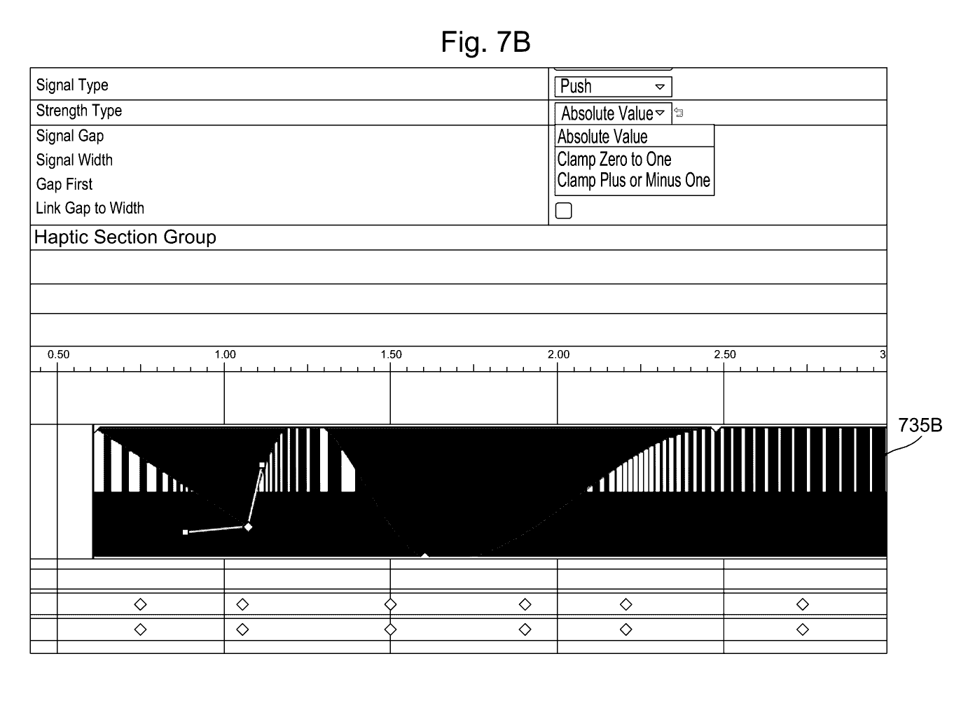

FIGS. 7A-7B illustrate haptic drive signals 735A, 735B according to other example embodiments of the present invention. FIG. 7A illustrates haptic drive signal 735A in which the strength type parameter has been set to “absolute value.” Here, the push/pull haptic drive signal may be rendered as a push only signal wherein the pull portions are converted to push portions using an absolute value algorithm. FIG. 7B illustrates haptic drive signal 735B in which the strength type parameter has been set to “clamp zero to one.” Here, the push/pull haptic drive signal may be rendered as a push only signal wherein the pull portions are removed from haptic drive signal 735B. The strength type parameter may be adjusted according to the characteristics of the actuator being used. For example, the “absolute value” or “clamp zero to one” settings may be selected when a mono-directional actuator (i.e., not a bidirectional actuator) is being used.

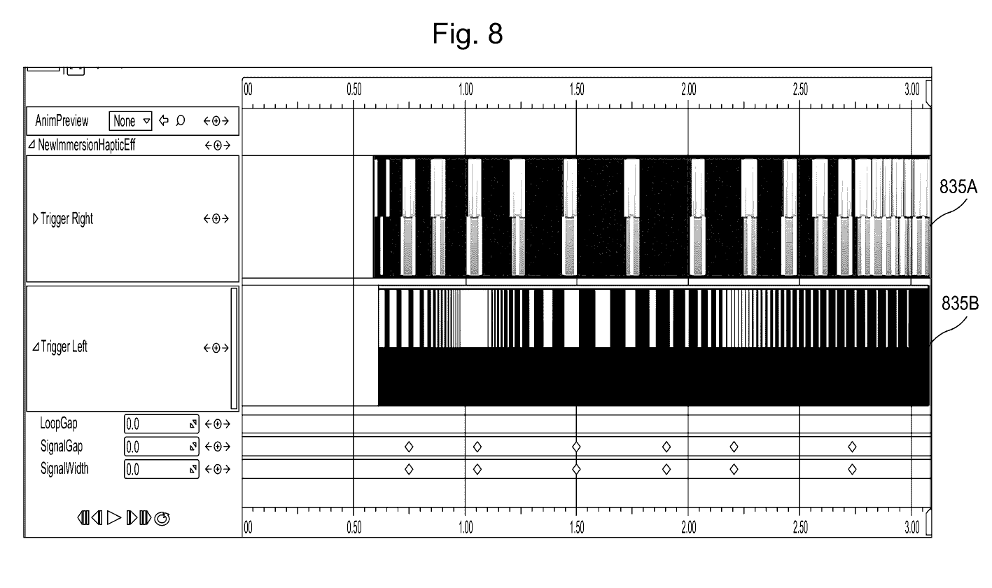

FIG. 8 illustrates multiple haptic drive signals 835A, 835B according to another example embodiment of the present invention. Each haptic drive signal 835A, 835B may correspond to one or more haptic channels or haptic output devices (e.g., trigger left, trigger right, etc.). Alternatively, multiple haptic drive signals, such as haptic drive signal 835A, 835B, may be simultaneously or sequentially applied to a single haptic output device.

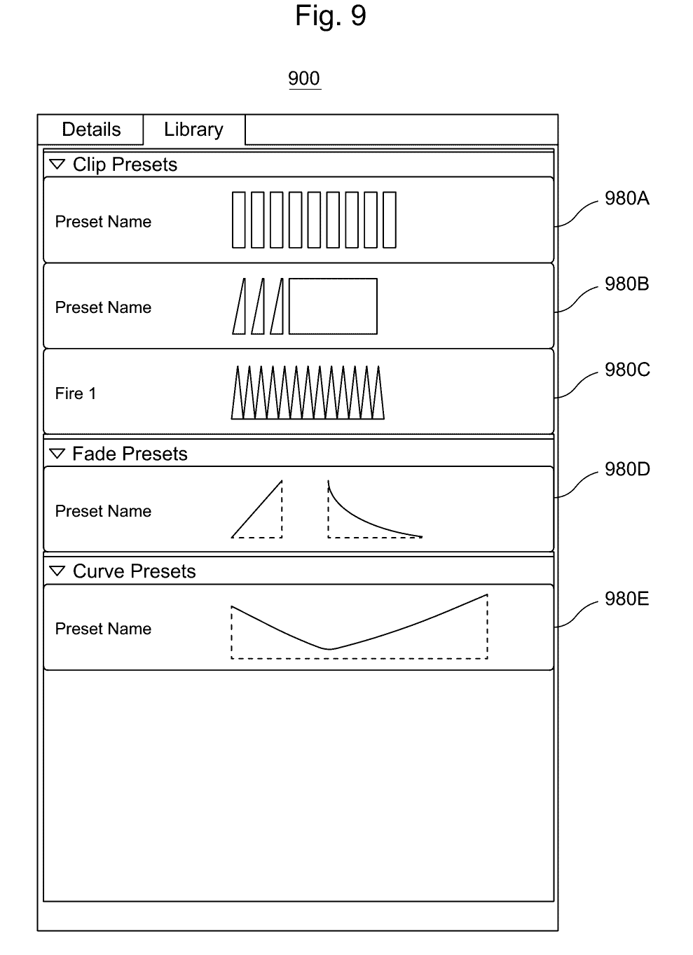

FIG. 9 illustrates a haptic preset library 900 according to an example embodiment of the present invention. As shown in FIG. 9, haptic present library 900 may include a variety of clip presets 980A-980C, as well as one or more haptic fade presets 980D and one or more curve presets 980E. Among haptic presets 980A-980E, certain haptic presets may be used in connection with certain event types of the application. For example, an explosion animation object may utilize one of fade presets 980D having maximum haptic strength at the outset and fading as the explosion comes to an end. Here, the fade-out (as well as fade-in) characteristics may be determined based on characteristics of the haptic output device (e.g., its maximum strength or a percentage thereof).

Thus, the example embodiments described herein provide systems and methods for designing and/or editing haptic effects. Animation objects and accompanying media effects are rendered in sync with the haptic effects to enable real-time preview and editing of the haptic effects in the application context. The improved haptic editing application enhances the range of haptic effects rendered by high quality haptic output devices and the haptic developer's ability to design or otherwise manipulate the haptic effects. The haptic effects may be rendered in real-time or during a playback of an animation object or other input.

Several embodiments have been specifically illustrated and/or described. However, it will be appreciated that modifications and variations of the disclosed embodiments are covered by the above teachings and within the purview of the appended claims without departing from the spirit and intended scope of the invention. The embodiments described herein are only some of the many possible implementations. Furthermore, the embodiments may be readily applied to various actuator types and other haptic output devices.

I claim:

1. A method for editing haptic effects, the method comprising:
retrieving an animation object;
associating a haptic effect with the animation object, the haptic effect having a corresponding haptic drive signal;
associating interpolation points with the haptic drive signal along a timeline;
adjusting one or more parameters of the haptic drive signal between successive interpolation points to generate a modified haptic effect; and
rendering the animation object and the modified haptic effects.

2. The method according to claim 1, wherein the animation object is based on motions of a user.

3. The method according to claim 1, wherein the haptic effect is a multi-frequency haptic effect that is rendered using a mono-frequency haptic output device.

4. The method according to claim 1, wherein the haptic effect is a texture haptic effect that is rendered by modifying multiple parameters of the haptic drive signal.

5. The method according to claim 1, wherein an envelope of the haptic drive signal is modified between successive control points of the haptic drive signal.

6. The method according to claim 1, wherein the parameters of the haptic drive signal are adjusted using a haptic library.

7. The method according to claim 1, wherein the parameters of the haptic drive signal are adjusted according to an event occurring within an application.

8. A non-transitory computer readable storage medium storing one or more programs configured to be executed by a processor, the one or more programs comprising instructions for:
retrieving an animation object;
associating a haptic effect with the animation object, the haptic effect having a corresponding haptic drive signal;
associating interpolation points with the haptic drive signal along a timeline;
adjusting one or more parameters of the haptic drive signal between successive interpolation points to generate a modified haptic effect; and
rendering the animation object and the modified haptic effects.

9. The non-transitory computer readable storage medium according to claim 8, wherein the animation object is based on motions of a user.

10. The non-transitory computer readable storage medium according to claim 8, wherein the haptic effect is a multi-frequency haptic effect that is rendered using a mono-frequency haptic output device.

11. The non-transitory computer readable storage medium according to claim 8, wherein the haptic effect is a texture haptic effect that is rendered by modifying multiple parameters of the haptic drive signal.

12. The non-transitory computer readable storage medium according to claim 8, wherein an envelope of the haptic drive signal is modified between successive control points of the haptic drive signal.

13. The non-transitory computer readable storage medium according to claim 8, wherein the parameters of the haptic drive signal are adjusted using a haptic library.

14. The non-transitory computer readable storage medium according to claim 8, wherein the parameters of the haptic drive signal are adjusted according to an event occurring within an application.

15. A device comprising:
a processor; and
a memory storing one or more programs for execution by the processor, the one or more programs including instructions for:
retrieving an animation object;
associating a haptic effect with the animation object, the haptic effect having a corresponding haptic drive signal;
associating interpolation points with the haptic drive signal along a timeline;
adjusting one or more parameters of the haptic drive signal between successive interpolation points to generate a modified haptic effect; and
rendering the animation object and the modified haptic effects.

16. The device according to claim 15, wherein the animation object is based on motions of a user.

17. The device according to claim 15, wherein the haptic effect is a multi-frequency haptic effect that is rendered using a mono-frequency haptic output device.

18. The device according to claim 15, wherein the haptic effect is a texture haptic effect that is rendered by modifying multiple parameters of the haptic drive signal.

19. The device according to claim 15, wherein an envelope of the haptic drive signal is modified between successive control points of the haptic drive signal.

20. The device according to claim 15, wherein the parameters of the haptic drive signal are adjusted using a haptic library.
